(19) United States
(12) Patent Application Publication
(10) Pub. No.: US 2017/0168697 A1
(43) Pub. Date: Jun. 15, 2017

(54) SYSTEMS AND METHODS FOR PLAYING VIDEOS

(71) Applicants: Shahar SHPALTER, Tel-Aviv (IL); Tom PACHYS, Tel-Aviv (IL); Chen SALOMON, Rehovot (IL)

(72) Inventors: Shahar SHPALTER, Tel-Aviv (IL); Tom PACHYS, Tel-Aviv (IL); Chen SALOMON, Rehovot (IL)

(21) Appl. No.: 15/335,576

(22) Filed: Oct. 27, 2016

Related U.S. Application Data
(60) Provisional application No. 62/264,950, filed on Dec. 9, 2015.

(51) Int. Cl. G06F 3/0484; G11B 27/22; H04N 21/6547; H04N 21/431; H04N 21/435; G11B 27/10; G06F 3/0482

(52) U.S. Cl. CPC G06F 3/04847; G11B 27/102; G11B 27/22; G06F 3/0482; H04N 21/4312; H04N 21/435; H04N 21/6547

(57) ABSTRACT

There is provided a computerized method for playing video, comprising: accessing, from a first server, a selected instruction set from a metadata file for adapting a player graphical user interface (GUI) layer according to user selected content including segments selected from video(s); accessing, from a second server(s), the video(s); analyzing the selected instruction set to identify chapter objects, each chapter object including instructions for playing a segment of the video(s); and rendering a player GUI layer for presentation of segments of the video(s) on a display of the client terminal, by adapting the player GUI layer by mapping user interface (UI) templates to chapter objects; receiving a user selection of one of the UI templates, and presenting the chapter object associated with the selected UI template while another chapter object associated with another UI template is simultaneously displayed.

### RELATED APPLICATION

This application claims the benefit of priority under 35 USC §119(e) of U.S. Provisional Patent Application No. 62/264,950 filed on Dec. 9, 2015, the contents of which are incorporated herein by reference in their entirety.

### FIELD AND BACKGROUND OF THE INVENTION

The present invention, in some embodiments thereof, relates to a systems and methods for playing videos and, more specifically, but not exclusively, to systems and methods for playing selected segments of one or more videos.

Users may create new videos and/or watch videos created from other videos, by editing and/or remixing the original videos to create a new video, re-exporting the video, and re-publishing source footage. Such videos are based on curating, remixing, repackaging, and repurposing videos by others, to create new videos. Such videos may have alternative sequencing than the original videos.

### SUMMARY OF THE INVENTION

According to an aspect of some embodiments of the present invention there is provided a computerized method for playing video at a client terminal, delivered from at least one server over a network according to a metadata file, the method performed by player code implemented by a processor of the client terminal, the method comprising: accessing, from a first server, a selected instruction set from a metadata file storing a plurality of instruction sets each for adapting a player graphical user interface (GUI) layer according to user selected content including a plurality of segments selected from at least one video; accessing, from at least one second server, the at least one video; analyzing the selected instruction set of the metadata file to identify a plurality of chapter objects, each chapter object including instructions for playing a segment of the at least one video; and rendering, according to the selected instruction set, a player GUI layer for presentation of a plurality of segments of the at least one video on a display of the client terminal, by adapting the player GUI layer by mapping each of a plurality of user interface (UI) templates to one of the plurality of chapter objects; receiving a user selection of one of the UI templates of the plurality of UI templates, and presenting the chapter object associated with the selected UI template while another chapter object associated with another UI template is simultaneously displayed.

Optionally, the method further comprises receiving a user selection of a certain UI template of the plurality of UI templates; and playing, within the player GUI layer, the segment of the video associated with the selected certain UI template according to instructions defined by the metadata file for the respective chapter object of the plurality of chapter objects, by obtaining the segment of the at least one video from the at least one second server over the network.

Optionally, the method further comprises accessing, from the first server, a GUI set-of-rules associated with the selected instruction set; executing the GUI set-of-rules; and customizing the rendered player GUI layer according to the GUI-set-of-rules. Optionally, executing the GUI set-of-rules comprises obtaining a user profile, and customizing comprises displaying chapter objects appropriate to a user based on the user profile. Alternatively or additionally, executing the GUI set-of-rules comprises querying available resources within a local environment of the client terminal, and customizing comprises adjusting the chapter objects for presentation based on the available resources. Alternatively or additionally, executing the GUI set-of-rules comprises querying a webpage associated with the selected instruction set for up-to-date data, and customizing comprises customizing the rendered player GUI layer based on the up-to-date data.

Optionally, the method further comprises automatically updating each UI template according to content of the segment of the video associated with each respective chapter object according to the metadata file, by presenting an image from the content within the UI template.

Optionally, the method further comprises automatically updating each UI template with text associated with each respective chapter object according to the metadata file.

Optionally, the metadata file includes a network address for obtaining at least one video, wherein the at least one second server is accessed according to the network address.

Optionally, metadata file defines, for each chapter object, a range of time of the video associated with the chapter object, wherein the range of time is shorter than the full range of time of the video.

Optionally, the method further comprises identifying a user selection of a network document, and wherein the accessing the metadata file from the first server is performed in response to the user selection.

Optionally, the method further comprises identifying a user selection of a hyperlink, and wherein the accessing the metadata file from the first server is performed in response to the user selection.

Optionally, the metadata file includes a definition of an order of presentation of the chapter objects. Optionally, the method further comprises continuously playing the segments of the at least one video according to the order.

Optionally, the method further comprises receiving a user selection for creation of a new chapter object within a location of the presented UI templates representing chapter objects; receiving a user selection of at least one video hosted by at least one second server; receiving at least one range of time representing a segment of the at least one video; automatically updating the instruction set of the metadata file with the at least one video and associated segment according to the location; and automatically updating the rendered player GUI layer based on the updated metadata file.

Optionally, the metadata file stores, for each chapter object, at least one member of the group consisting of: thumbnail image, headline, description, tag, share universal resource locator (URL), view metrics, like, dislike, associated chapters, a poll, a trivia question, a smart annotation, and sub-chapter objects.

Optionally, the metadata stores instructions to present a dynamic element in association with the respective chapter object that adapts according to the image or scene of the associated video segment being played in real-time, based on content analysis performed on at least one frame dynamically extracted from the video segment.

Optionally, the metadata stores a plurality of sub-chapter objects for at least one chapter object of the plurality of chapter objects, wherein the sub-chapter objects inherit at least one metadata parameter from the at least one chapter object, wherein each sub-chapter object is stored as an independent chapter object.

Optionally, the user selects the order for presentation of the video segments of the chapter objects.

According to an aspect of some embodiments of the present invention there is provided a system for playing video, comprising: a client terminal comprising: a display; a first server interface for communicating with a first server storing a metadata file storing a plurality of instruction sets each for adapting a player graphical user interface (GUI) layer according to user selected content including a plurality of segments selected from at least one video; a second server interface for communicating with at least one second server storing the at least one video; a program store storing player code; and a processor coupled to the display, the first server interface, the second server interface, and the program store for implementing the stored player code, the player code comprising: code to access a selected instruction set from the metadata file using the first server interface, and analyze the selected instruction set of the metadata file to identify a plurality of chapter objects, each chapter object including instructions for playing a segment of the at least one video obtained using the second server interface; and code to render, according to the selected instruction set, a player GUI layer for presentation of a plurality of segments of the at least one video on the display, by adapting the player GUI layer by mapping each of a plurality of UI templates to one of the plurality of chapter objects; and code to receiving a user selection of one of the UI templates of the plurality of UI templates, and present the chapter object associated with the selected UI template while another chapter object associated with another UI template is simultaneously displayed.

Optionally, the player code further comprises instructions to store the selected instructions set of the metadata file in a local memory of the client terminal.

Optionally, the player code further comprises instructions for releasing the selected instruction set of the metadata file and stored videos obtained from the at least one second server, from storage in a local memory of the client terminal when execution of the rendered GUI is terminated.

Optionally, the player code further comprises instructions for presenting an indication of the chapter object of the plurality of chapter objects having a video segment being presented, and a progress icon representing elapsed time of the segment of the video being presented from the start of the segment associated with the chapter object.

According to an aspect of some embodiments of the present invention there is provided a computer program product comprising a non-transitory computer readable storage medium storing program code thereon for implementation by a processor of a client terminal for playing video segments, the program code comprising instructions to: access, from a first server, a selected instruction set from a metadata file storing a plurality of instruction sets each for adapting a player graphical user interface (GUI) layer according to user selected content including a plurality of segments selected from at least one video; access, from at least one second server, the at least one video; analyze the selected instruction set of the metadata file to identify a plurality of chapter objects, each chapter object including instructions for playing a segment of the at least one video; and render, according to the selected instruction set, a player GUI layer for presentation of a plurality of segments of the at least one video on a display of the client terminal, by adapting the player GUI layer by mapping each of a plurality of user interface (UI) templates to one of the plurality of chapter objects; receive a user selection of one of the UI templates of the plurality of UI templates, and presenting the chapter object associated with the selected UI template while another chapter object associated with another UI template is simultaneously displayed.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method for playing at a client terminal video segments of one or more complete videos obtained from video server(s) according to a metadata file defining chapter objects obtained from a metadata server, in accordance with some embodiments of the present invention;

FIG. 2 is a block diagram of a system that plays segments of one or more videos obtained from video server(s) according to a metadata file obtained from a metadata server, in accordance with some embodiments of the present invention;

FIG. 3 is a flowchart of a method for editing chapter objects, in accordance with some embodiments of the present invention;

FIG. 4 is a schematic depicting ordering of multiple segments from multiple videos, each represented as chapter objects, which are defined by the metadata file, in accordance with some embodiments of the present invention;

FIG. 5 is a schematic of an exemplary architecture implementing the metadata file, stored chapter objects, and associated metadata parameters, in accordance with some embodiments of the present invention;

FIG. 6 is a schematic representation of an exemplary rendered player GUI layer presenting UI templates corresponding to chapter objects defined by the metadata file, in accordance with some embodiments of the present invention;

FIG. 7 is a screen capture of an exemplary rendered player GUI layer, in accordance with some embodiments of the present invention;

FIG. 8 is a schematic of components based on the systems and/or methods described herein for editing chapter objects, in accordance with some embodiments of the present invention;

FIG. 9 is a schematic of an exemplary player GUI layer for editing chapter objects, in accordance with some embodiments of the present invention;

FIG. 10 is a screen capture of an exemplary implementation of a player GUI layer for editing chapter objects, in accordance with some embodiments of the present invention;

FIG. 11 is a schematic representing high-level dataflow based on the method described with reference to FIG. 1 and/or system 200 described with reference to FIG. 2, in accordance with some embodiments of the present invention;

FIG. 12 is another schematic representing high-level dataflow based on the method described with reference to FIG. 1 and/or system 200 described with reference to FIG. 2, in accordance with some embodiments of the present invention;

FIG. 13 is a high-level block diagram depicting dataflow between different components, in accordance with some embodiments of the present invention;

FIG. 14 is a dataflow diagram depicting flow of data between different system components, based on the systems and/or methods described herein, in accordance with some embodiments of the present invention;

FIG. 15, which is another dataflow diagram depicting flow of data between different system components, based on the systems and/or methods described herein, in accordance with some embodiments of the present invention;

FIG. 16 is another dataflow diagram depicting flow of data between different system components, based on the systems and/or methods described herein, in accordance with some embodiments of the present invention; and

FIG. 17 is a schematic including a progress bar representing elapsed time of the playing video segment, in accordance with some embodiments of the present invention.

### DESCRIPTION OF SPECIFIC EMBODIMENTS OF THE INVENTION

The present invention, in some embodiments thereof, relates to a systems and methods for playing videos and, more specifically, but not exclusively, to systems and methods for playing selected segments of one or more videos.

An aspect of some embodiments of the present invention relates to systems and/or methods (e.g., player code stored in a program store executed by a processor) that play user selected segments from one or more videos (which may include different videos) within a player graphical user interface (GUI) layer presented on a display of a client terminal according to a metadata file that defines chapter objects each defining a segment (i.e., playing time range) from a video. The metadata file stores multiple instruction sets, each for adapted the player GUI layer according to user selected content including video segments selected from the video(s). The player code automatically renders the player GUI layer based on the selected instruction set within the metadata file, by adapting the player GUI layer. Each of multiple user interface (UI) templates of the player GUI layer is mapped to a chapter object. The player code analyzes the metadata file identify the mapped chapter objects, and the video segments defined by the respective chapter object. A user may navigate the player GUI layer, by selecting UI templates, optionally in any order. The player GUI layer plays the video segment associated with the chapter object of the selected UI template. The user may select different UI templates for playing.

The metadata file is stored separately from the videos, optionally on different servers accessible by the player code over the network. The metadata file defines the order of the chapter objects, and the order of the playing of the segments. The chapter objects are presented as user interface UI templates of the player GUI layer, allowing a user to navigate playing of the segments, for example, to play the video segment associated with respective chapter objects in a user selected order. The videos may be stored in their original format (i.e., the complete version), with chapter objects defined by the metadata file, which may allow, for example, the same originally stored video to be used in multiple different chapter objects, by selecting different segments of the stored video, and/or playing the different selected segments in different orders.

Optionally, the player code automatically updates each UI template according to the metadata file associated with the chapter object of the UI template. The player code may automatically insert images and/or text within the UI template based on the metadata file and/or the content of the video segment (e.g., obtained from the content of the video segment associated with the chapter object).

Hyperlinks may point to the metadata file storing a set of chapter objects. Hyperlinks may point to individual chapter objects within the metadata file. Hyperlink(s) to the metadata file (individual or set of chapter objects) may be embedded within network documents (e.g., web pages). Optionally, the rendering of the player GUI layer is triggered by a selection of the hyperlink(s) and/or opening of the network document that includes the hyperlinks to the metadata file. Chapter objects may be embedded by users within network documents using the hyperlinks.

Optionally, users may edit and/or create new chapter objects, using the player GUI layer or another interface. The user may define the location of a video hosted by a server (i.e., a complete version of the video). The user may define one or more segments of the video, optionally by defining a range of time of the video, for example, defining a start time and an end time of each segment. The user may select the order of the segments. The player code may automatically update the metadata file with instructions defining the new chapter object. The rendered player GUI layer may be automatically updated to include the edited and/or new chapter objects according to the updated metadata file.

The systems and/or methods described herein provide a technical solution to the technical problem of improving the process of remixing segments from one or more videos. The systems and/or methods described herein provide a layer of abstraction (i.e., the metadata file stored in a metadata server) above the existing complete videos stored on one or more video servers. The metadata file defines chapter objects, each of which defines the location of the segment within a respective video. The metadata file may define the order of playing of the video segments within the chapter objects. Segments of the videos may be played according to the metadata file without necessarily requiring storing additional data and/or making modifications to the original complete video. The original complete video and/or video server hosting the original complete video may be unaware of the processing performed by the player code according to the metadata file. Some awareness may be allowed, for example, to record metrics related to viewing.

The systems and/or methods described herein improve performance of computers, (e.g., client terminal, server(s)) and/or a network, and/or may relate to the technical problem of improving transmission of video packets over a network and/or reducing storage requirements for storing videos. The metadata file defines a sequence of segments of one or more videos using chapter objects. The metadata file, which defines a new video remix based on one or more other complete videos, requires significantly less storage space than storage of a playable version of the new video remix. Moreover, the same complete video may be used for multiple different chapter objects. Since each chapter object is defined by the metadata file, the storage space required includes the original complete video and metadata file, instead of, for example, creating copies of the original complete video each time each time a segment is used. In effect, there is no edited and/or remixed video that requires storage. Network utilization may be reduced by reducing network traffic of video packets transmitted over the network, for example, by accessing video servers hosting the complete videos to stream (or download) the segment that the user selected to view, instead of, for example, streaming or downloading a complete re-mixed video that includes portions that the user is not interested in.

The systems and/or methods described herein create new data in the form of the metadata file, which is stored in a physical storage location of a physical metadata file server. Chapter objects may be automatically created within the metadata file by player code that converts user editing actions into the chapter objects, for example, creation of new chapter objects, deletion of existing chapter objects, and/or editing of chapter objects.

Accordingly, the systems and/or methods described herein are necessarily rooted in computer technology to overcome an actual technical problem arising in video processing, network communication, and/or storage of videos.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As used herein, the term complete video means the original video stored on the video server, for example, the video as uploaded by a user. For example, the video may have a length of one hour and fifty three minutes and twenty two seconds (1:53:22).

As used herein, the term video segment means a segment of the original video, defined by a time interval, which may include a start time, and end time, or start time and elapsed time from the start time. The total segment time may be calculated from the start and end time. For example, for the complete video of length 1:53:22, a segment may be defined as having a start time of 19 minutes and 48 seconds, and an end time of 20 minutes and 33 seconds.

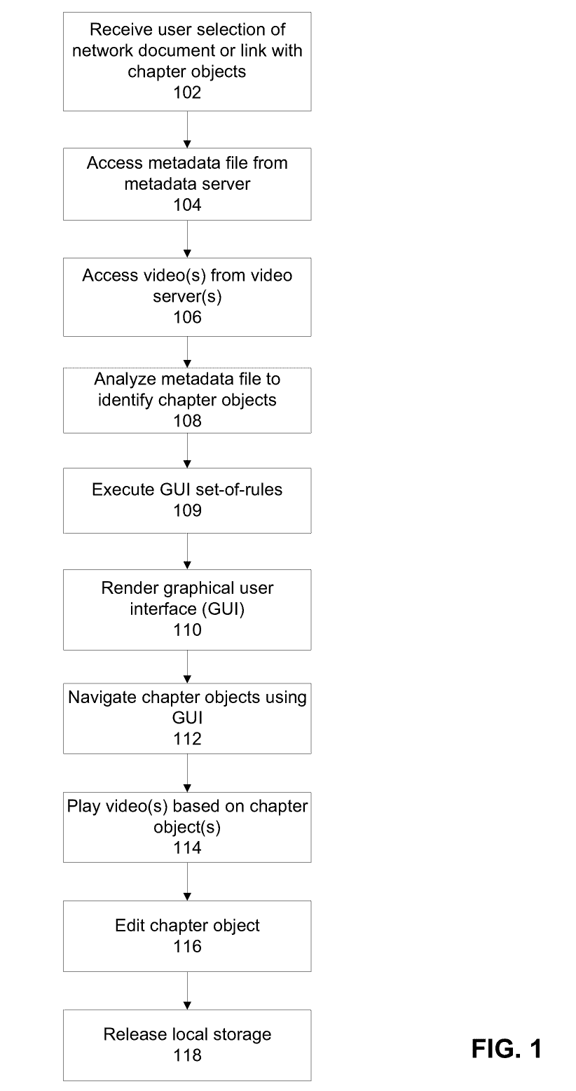

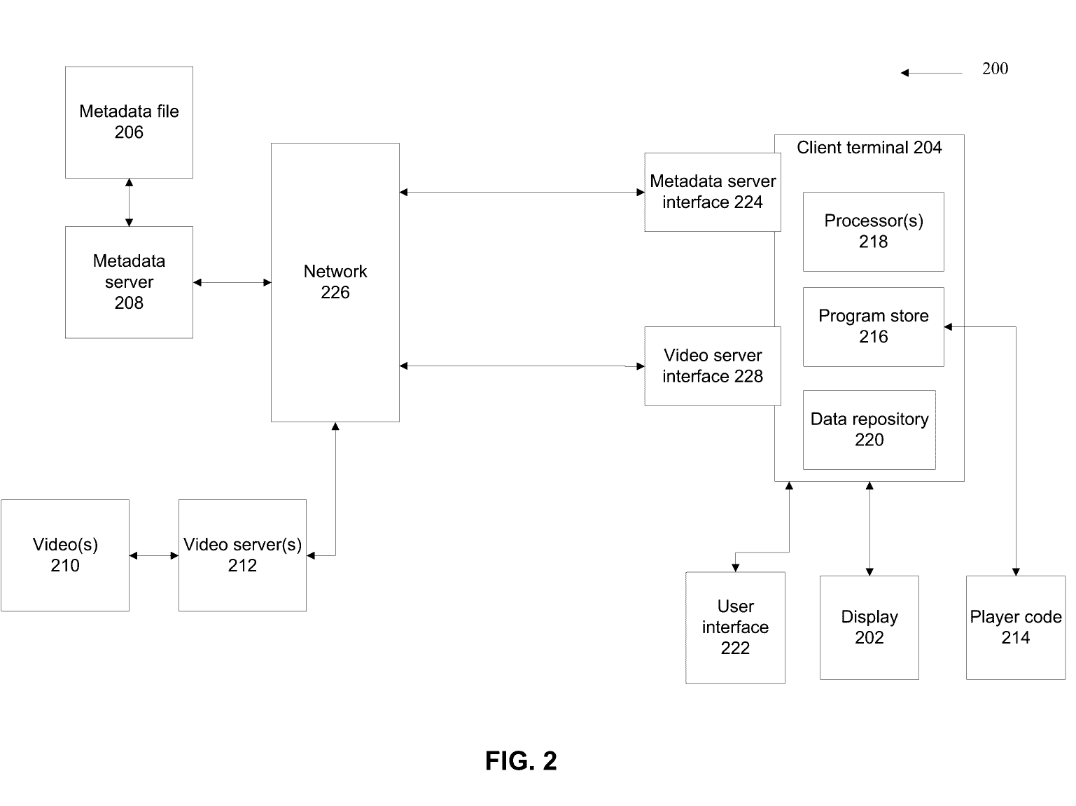

Reference is now made to FIG. 1, which is a flowchart of a method for playing at a client terminal video segments of one or more complete videos obtained from video server(s) according to a metadata file defining chapter objects obtained from a metadata server, in accordance with some embodiments of the present invention. Reference is also made to FIG. 2, which is a block diagram of a system 200 that allows a user to use a rendered player GUI layer presented on a display 202 of a client terminal 204 to navigate chapter objects of a metadata file(s) 206 obtained from a metadata server 208, where each chapter object links to a segment of a video 210 stored on a video server 212, in accordance with some embodiments of the present invention. The acts of the method of FIG. 1 may be implemented by system 200 of FIG. 2, optionally by player code 214 stored in program store 216 implementable by processor 218 of client terminal 204.

The systems and/or methods described herein allow viewers to control the way in which the video segments associated with chapter objects are viewed, for example, users may skip between segments, play segments in any order, which may be non-linear (i.e., not necessarily following a predefined order of the chapter objects and/or following the order of the original complete video). Each chapter object is processed independently, and may contain data independent of other chapter objects for example, its own assets and/or attributes, for example, thumbnail (e.g., image, video, GIF), headline, description, tag, share URL, and view metrics.

The systems and/or methods described herein do not edit or otherwise mark or modify the original complete video. The definition of segments is performed based on the metadata file, which represents a higher level of abstraction above the complete video. Video segments may be created by chopping segments from the complete videos, and stitching the video segments in a user defined order.

Editing of chapter objects (i.e., deletion of video segments, modification of the video segment, addition of a new video segment) may be performed on the fly, with the edited chapter object available for other users, for example, in comparison to editing of original videos and/or remixed video which is more difficult and time consuming.

System 200 includes client terminal 204, for example, a mobile device, a desktop computer, a thin client, a Smartphone, a Tablet computer, a laptop computer, a server, a wearable computer, glasses computer, and a watch computer. Client terminal 204 includes one or more processors 218, for example, a central processing unit(s) (CPU), a graphics processing unit(s) (GPU), field programmable gate array(s) (FPGA), digital signal processor(s) (DSP), and application specific integrated circuit(s) (ASIC). Processor(s) 218 may include one or more processors (homogenous or heterogeneous), which may be arranged for parallel processing, as clusters and/or as one or more multi core processing units.

Client terminal 204 includes program store 216 storing code instructions implementable by processor(s) 218, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Player code 214 may be stored by program store 216.

Client terminal 204 may include a data repository 220 (e.g., memory, hard drive, optical disc, storage device) that stores a copy of metadata file 206 obtained from metadata server 208, and/or stores copies of segments of videos 210 obtained from video server 212 as defined by metadata file 206 for presentation on display 202.

Client terminal 204 includes or is in communication with a user interface 222 (which may be integrated with display 202, or a separate device), for example, a touchscreen, a keyboard, a mouse, and voice activated software using speakers and microphone.

Client terminal 204 includes or is in communication with a metadata server interface 224 for communicating with metadata server 208 over network 226. Client terminal 204 includes or is in communication with a video server interface 228 for communicating with one or more video servers 212 over network 226. Interfaces 224 and 228 may be implemented as a single interface, or separate interfaces, optionally as a network interface, for example, a cable interface, a physical interface, a virtual interface, and/or a wireless interface. Examples of network 226 include one or more of: the internet, a wireless network, a private network, a local area network, and a cellular network.

At 102, a user selection of a network document (e.g., webpage hosted on a web browser) and/or hyperlink (or other instructions, for example a script) is identified by player code 214 stored in program store 216 implemented by processor 218 of client terminal 204. The network document and/or hyperlink may include instructions to trigger access of the metadata file and rendering of the player GUI layer, as described herein.

The user selection may be performed, for example, by the user using a web browser to open a link or web page that includes the instructions to access the metadata file. The chapter objects may be embedded within the network document, for example, as hyperlinks, a script, or other code.

The network document may include multiple hyperlinks, for example, each representing a chapter object stored in the metadata file. The network document may include a single hyperlink that points to a set of chapter objects in the metadata file.

At 104, metadata file 206 is accessed by player code 214 accessing metadata server 208 via network 226. Opening of the network document and/or selection of the link (i.e., block 102) may automatically trigger player code 214 to obtain metadata file 206.

Metadata file 206 may be stored, for example, as file, as a database, a script, in human readable format, in machine readable format, as an application programming interface (API), or other formats.

Metadata file 206 stores multiple instruction sets, and/or metadata that may be parsed into instruction sets for execution by a processor, for example, a script, human readable text, machine readable code, and/or other instructions and/or encoding methods. Each set of instructions defines an adaptation of a player GUI layer according to user selected content. The user selected content includes multiple segments selected from one or more videos stored on video server(s).

Metadata file 206 may store multiple chapter objects, for example, as database entries, as indexable code, and/or using other formats.

Metadata file 206 defines a segment for each chapter object based on an associated complete video 210 stored on video server 212. The segment may be defined by a range of time, such as defined using a start time and end time, or start time and duration from start time. The segment is shorter than the complete video, but may start or end according to the start or end of the complete video. For example, metadata file 206 may define a sequence of segments (as chapter objects) from the same complete video, played in a different order than that in which they appear in the complete video. In another example, metadata file 206 may define a sequence of segments (as chapter objects) obtained from two different complete video (which may be stored on different video servers or the same video server).

The metadata file may include, in association with each chapter object, a network address of the video segment of the chapter object, for example, a network address (e.g., universal resource locator (URL)) of video server 212 hosting the complete video, optionally a hyperlink to the complete video.

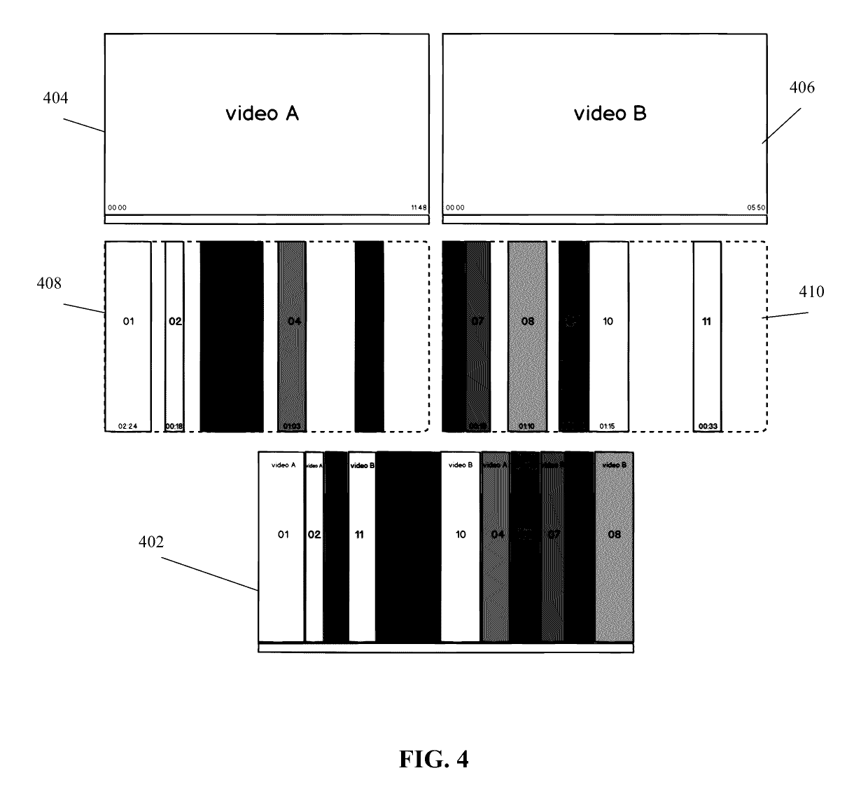

Reference is now made to FIG. 4, which is a schematic depicting ordering of multiple segments from multiple videos, each represented as chapter objects, which are defined by the metadata file, in accordance with some embodiments of the present invention. Data stored in metadata file 402 defines chapter objects, optionally in a defined order. Each chapter object represents a respective segment from video A 404 or video B 406. The ordering of the chapter objects is independent of which video (A or B) the segment is derived from and/or in dependent of the location of the segment (e.g., according to time) within the video. For example, segments derived from video A 404 are schematically represented by image 408 and segments of video B 406 are shown by image 410. Time spans of video A 404 and video B 406 are shown as numbered blocks 01-05 in image 408 and blocks 06-11 in image 410, numbered according to ordering based on time. Metadata 402 may define the segments from the different videos in a different order, for example, based on user selection.

Referring now back to block 104 of FIG. 1, the metadata file may store additional data in the form of metadata parameters for each chapter object, for example, as values in metadata field parameters stored within each chapter object. Examples of additional metadata parameters include, one or more of:
Thumbnail image(s) for presentation within the UI template associated with the chapter object. The thumbnail may be a dynamic element (e.g., animation, changing images) that adapts according to the image or scene of the associated video segment being played in real-time, that changes according to elapsed time of the video segment, and/or according to other functions based on dynamic data. For example, the thumbnail may be automatically updated based on video analysis and/or content analysis performed on one or more frames extracted from the video segment, in real-time, or in advance. For example, in a video segment of a baseball game, the thumbnail may be dynamically changed to show a picture of the baseball player that is active in the frame or scene of the video segment.
Headline(s) (e.g., text) for presentation within the UI template associated with the chapter object.
Description(s) of the chapter object, such as in text format. The description may be presented within the UI template upon rendering of the player GUI layer, or accessible by the user to obtain more information, for example, by clicking a more-information link in the UI template.
Tag(s) and/or smart annotations for the chapter object. For example, a content category tag (e.g., song, game show, reality TV show, drama, news clip), a tag indicating video quality (e.g., resolution), a date tag, and/or other tag types. The tags may be manually and/or automatically generated. The tags may be used by applications and/or player code, for example, to perform searches for chapter objects.
A share URL to allow other users to link to the chapter object, and/or embed the chapter object within their own network documents (e.g., personal profile web page).
View metrics that store metrics related to users that viewed the chapter object.
Likes/dislikes that may include the number of others users that selected like or dislike for the chapter object, and/or other feedback and/or comments submitted by other users.
Associated chapters, for example, links to other chapter objects that are related to the chapter object. The associated chapters may be manually selected by the user and/or manually selected by software. The associated chapters may be selected based on similar tags, and/or other chapter objects that viewers that viewed this chapter object also viewed.
A poll and/or trivia question. The poll and/or trivia question may be related to the content chapter object.
Dynamic data, which may be calculated and/or represent the most updated data at the time of access, for example, chapter object views, number of likes, number of shares, and comments.
Ads for display with the chapter object, which may be obtained, for example, by accessing an ad server.

The metadata file may includes a definition of the order of presentation of the chapter objects, for example, which chapter object is chapter 1, which is chapter 2, and which is chapter 3.

The metadata may stores sub-chapter objects for one or more of the chapter objects. The sub-chapter objects may inherit one metadata parameter values from the parent chapter object. The sub-chapter objects may be chapter objects (which may be independent of one another) defined by the metadata as being sub-chapters of a parent object. Selection of a chapter object defined by the metadata object as being a parent displays the associated sub-chapters. Sub-chapters may be nested at multiple levels, such as a sub-chapter acting as a parent for sub-sub-chapters. For example, the metadata file may define a parent chapter as best world cup games. The metadata may define 5 other chapter objects, each representing a selected segment from different world cup games. In another example, sub-chapters may be organized by content, by scenes including certain player(s), by genre, by resolution quality, or other methods.

Optionally, the player code stores a copy of the obtained metadata file 206 in a local memory of the client terminal, for example, in data repository 220.

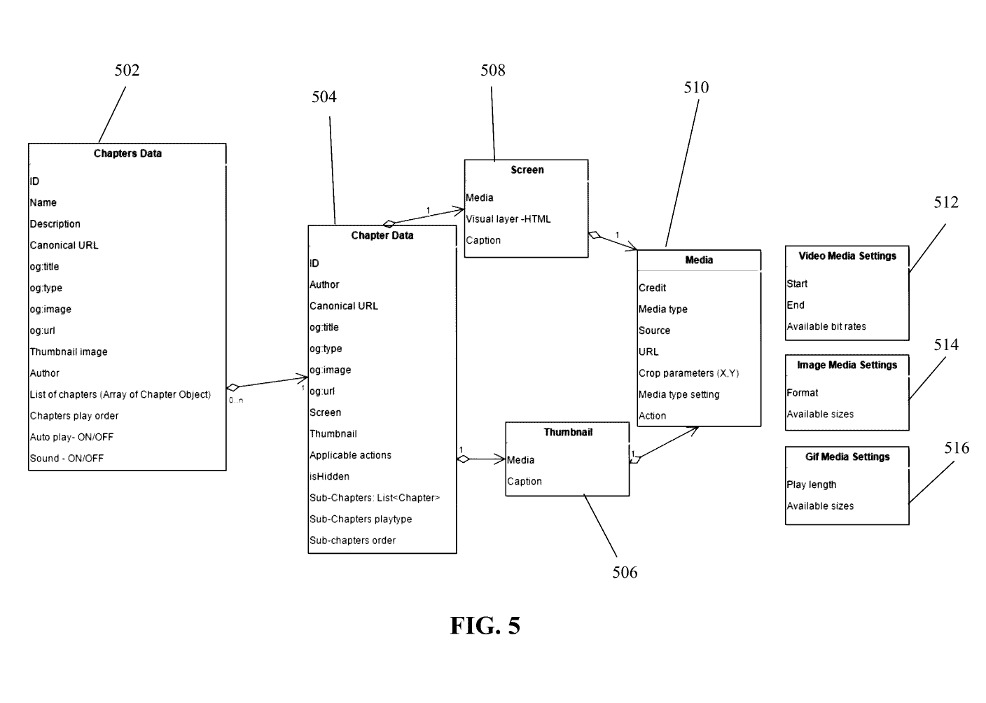

Reference is now made to FIG. 5, which is a schematic of an exemplary architecture implementing the metadata file, stored chapter objects, and associated metadata parameters, in accordance with some embodiments of the present invention. Block 502 represents a chapter object of multiple chapter objects stored by metadata file. Block 502 includes data describing the chapter object, and/or data for rendering of the player GUI layer to present the chapter object. The data may inherited by sub-chapters. Block 504 represents a sub-chapter object (of multiple sub-chapter objects) related to block 502. Block 506 represents a thumbnail, and includes data defining the presentation with the chapter object. Block 508 includes data to define the presentation of the chapter object in the rendered player GUI layer. Block 510 represents the complete video associated with the chapter object, including data of the complete video, for example, URL. Block 512 represents the segment, and includes data for deriving the segment from the complete video, for example, start and end times relative to the complete video. Block 514 represents image media settings. Block 516 represents GIF media settings.

At 106, one or more videos 210 are accessed from one or more video servers 212 storing the videos, by player code 214 according to the instructions of accessed metadata file 206. The videos segments may be accessed using the network addressed stored in metadata file 206 (e.g., for each chapter object).

One or more segments are identified for each video according to the chapter objects defined by the metadata file 206.

The segments may be prepared for streaming to client terminal 204, for example, placed in a queue for playing according to the chapter objects of metadata file 206. Alternatively or additionally, the segments may be downloaded and stored in data repository 220.

At 108, the metadata file (and/or the selection instruction set) is analyzed by player code 214, to identify chapter objects. For example, the metadata file may be parsed according to chapter objects, and/or the chapter objects may be identified by an index, database entries, or other methods.

At 109, a GUI set-of-rules is executed by client terminal 204. The GUI set-of-rules may be stored within the metadata and/or with the selected instruction set, or externally (e.g., as a file, as a script, as other instructions) in association with the metadata. Optionally, the GUI set-of-rules is downloaded from metadata server 208 (or another external storage location) by client terminal 204 (e.g., locally stored in a memory, such as program store 216).

The GUI set-of-rules may provide digital rights management (DRM), at the chapter level, at the client terminal level, at the use level, and/or other defined levels, for example, defining who is allowed to view which chapter objects. The GUI set-of-rules may define customizations of the chapter objects.

The GUI set-of-rules is defined per chapter object and/or at the client terminal level (e.g., implemented for all chapter objects executed at the client terminal). The GUI set-of-rules may be defined per user, for example, according a user profile (which may be locally and/or remotely stored).

The GUI set-of-rules may define which chapter objects are rendered in the GUI, and/or how chapter objects are rendered. For example, the set-of-rules may present chapter objects according to the age of the user, to ensure that only age appropriate content is presented. For example, segments of videos designated as Restricted are not presented to children under 18.

The GUI set-of-rules may define the chapter objects based on the webpage in which the chapter objects have been embedded, or other webpages. The same chapter objects, embedded in different web pages may be associated with different GUI set-of-rules. The GUI set-of-rules may issue a query to get feedback from the webpage(s), for example, the most updated ranking of a song in the charts may be received from the webpage.

The GUI set-of-rules may query the local environment of the client terminal, for example, display resolution, display type, operating system, processor resources, local memory resources, and internet connectivity.

The GUI set-of-rules may customize the presentation of one or more chapter objects, for example, defining whether to autoplay video segment or not (e.g., depending on available processing resources, memory, and/or connectivity), which thumbnail types to present (e.g., dynamic, static, none), the color of the chapter object, the order of the chapter object (e.g., based on updated ranking of the videos in the charts), and presentation of ads (e.g., matching ads to the user profile).

At 110, a player GUI layer is automatically rendered by player code 214 (optionally according to the selected instruction set) for presentation on display 202 of (or in communication with) client terminal 204, optionally in accordance with the executed GUI set-of-rules. The rendered GUI player may be customized based on the GUI-set-of-rules. The rendered player GUI layer includes multiple UI templates (e.g., one or more of: tabs, icons, buttons, video playing boxes, thumbnails, text boxes, image placeholders) which are adapted based on the analyzed metadata file, optionally by mapping each UI template to one of the identified chapter objects. The UI templates may be ordered according to ordering defined by the metadata file.

The player GUI layer may be based on a generic and/or empty design, which is filled in and/or adapted with the user selected content (i.e., user selected video segments) and/or user defined formatting (e.g., color, text description, ordering of chapter objects) according to the selected instruction set of the metadata file.

Optionally, each UI template is automatically updated according to content of the segment of the video associated with each respective chapter object, for example, presentation of an image within a thumbnail within the UI template. Optionally, the image is automatically captured from the content of the video segment and presented within the UI template, for example, by image processing software that analyzes the video segment and extracts an image that appears representative of the segment. Alternatively or additionally, the image defined by the metadata parameter for the chapter object is obtained and presented within the UI template.

Optionally, each UI template is automatically updated with text associated with the chapter object, for example, as a headline appearing within the UI template. The text may be obtained from the text stored in the metadata parameter of the chapter object. The text may be automatically obtained from content of the video segment, for example, by image processing software that analyzes the video segment and extracts text that appears to be representative of the segment.

Optionally, the rendered player GUI layer includes an indication of which chapter object of the chapter objects defined by the metadata file is having its video segment being played. For example, the UI templates of the chapter objects may be presented as tabs, with the video segment of the currently selected tab being played.

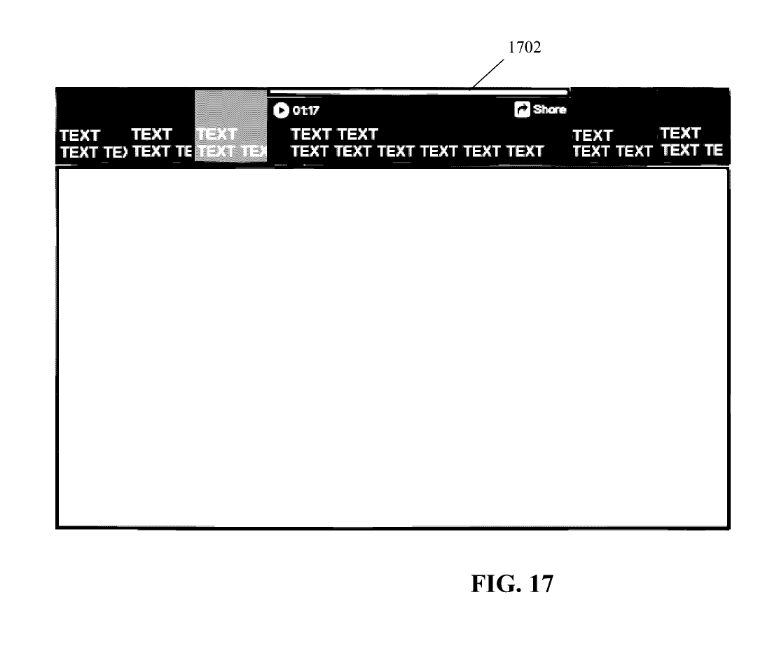

Optionally, the rendered UI includes a progress icon (e.g., progress bar) representing elapsed time of the segment of the video being presented. The progress icon may indicate the elapsed time from the start of the segment, rather than, for example, viewing time from the start of the complete video. The progress bar may indicate the total time duration of the video segment. Reference is now made to FIG. 17, which is a schematic of an exemplary player GUI layer playing the video segment of the complete video, and a progress bar 1702 representing elapsed time of the segment, without reference to the time relative to the complete video, in accordance with some embodiments of the present invention.

Optionally, each UI template representing each chapter object is rendered as a tab. Optionally, a preview of the respective video segment is displayed on the tab, based on stored metadata parameters, and/or automatically selected from content of the video segment.

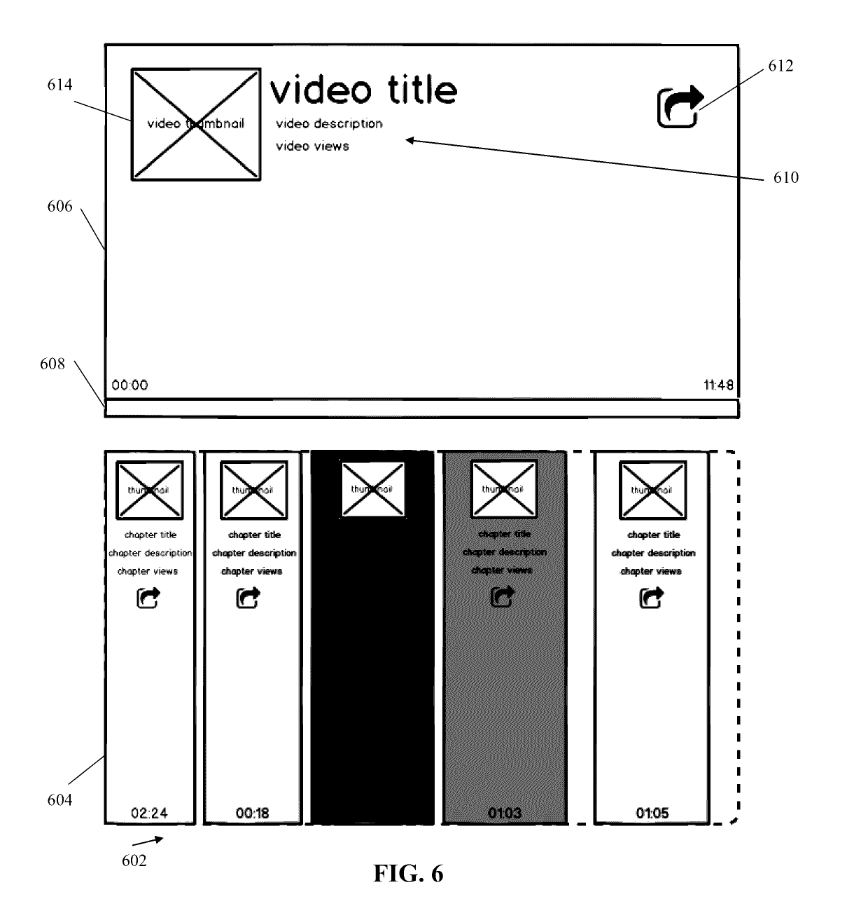

Reference is now made to FIG. 6, which is a schematic representation of an exemplary rendered player GUI layer presenting UI templates corresponding to chapter objects defined by the metadata file, in accordance with some embodiments of the present invention. Rendered player GUI layer 602 includes multiple UI templates (one UI template 604 marked for clarity) each representing a chapter object defined by the metadata file. Each UI template 604 may include additional data related to the chapter object, for example, a thumbnail (e.g., defined or automatically rendered), chapter title, chapter description, and chapter views details. Another screen 606 of the player GUI layer schematically represents viewing of the video segment of one of the chapter objects (e.g., by selecting the UI template). Screen 606 may include a bar 608 showing elapsed time relative to the segment (i.e., 0 for the start of the segment, even when the segment is located within the video), a thumbnail 614, additional data 610 (e.g., title, description, view data), and an icon 612 to skip to the next chapter.

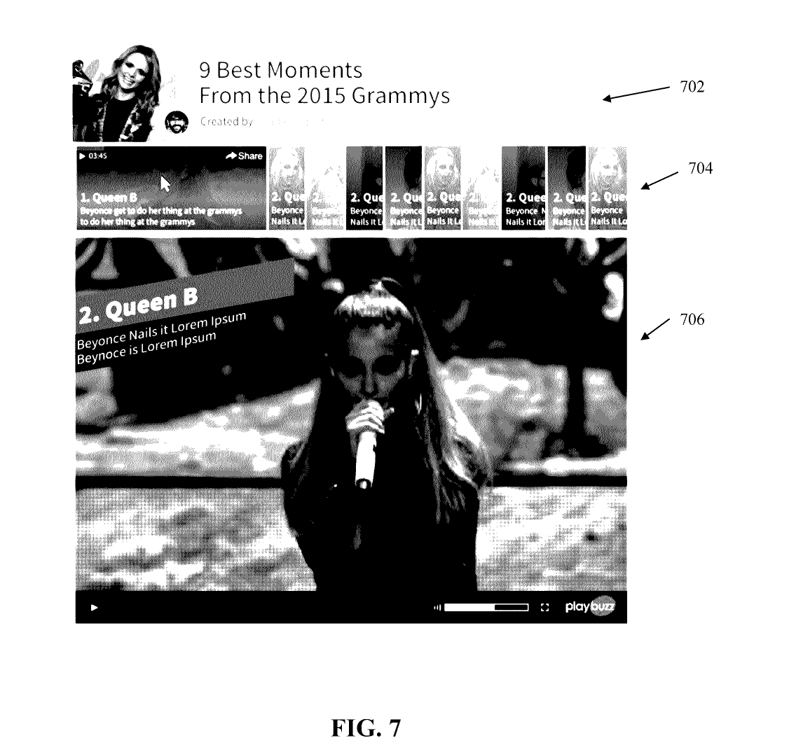

Reference is now made to FIG. 7, which is a screen capture of an exemplary rendered player GUI layer, in accordance with some embodiments of the present invention. The player GUI layer may include a title 702, which may be manually defined by the user and/or automatically generated based on an analysis of a common parameter of content of the video segment of the set of chapter objects. Player GUI layer includes UI templates 704, optionally tabs, each representing a chapter object. Player GUI layer plays the segment video of the selected chapter object within a window 706.

Referring now back to FIG. 1, at 112, the user may navigate the chapter objects using the UI templates of the rendered player GUI layer. The user may navigate between video segments, using the predefined order (i.e., ordering of the chapter objects), or using a user defined order (e.g., selecting chapter objects according to user preference, which may be different than the chapter ordering). For example, when the player GUI layer presents three chapter objects, the user may select chapter 3, then chapter 1, then chapter 3 again, and followed by chapter 2.

The user may select one of the UI templates (e.g., a tab) presented by the player GUI object while another UI template is simultaneously displayed. The chapter object and/or video segment of the selected UI template is played while the other chapter object and/or other video segment of the other UI template is simultaneously displayed.

The user may navigate within the video segment of each chapter object, for example, the user may view the playing video segment from start to finish, may pause the playing segment, may start a paused segment, may rewind a segment, or may start viewing from a different time in the segment.

A user selection of a certain UI template of the player GUI layer may be received.

The player GUI layer may include code to allow users to perform one or more of the following navigation features:
Selection of the chapter object, independently of the order of the chapter objects, for example, by clicking on a tag.
Share one or more selected chapter objects, for example, using social networks, email, and network messages.
Pause and resume playing of one or more video segment.
Turn sound off and on for one or more playing video segments.
Search through one or more chapter objects.
See chapter completion indications.

At 114, the video segments of the respective chapter objects presented by the rendered player GUI layer are played. The playing may be performed by an existing video player (e.g., locally stored on a memory of the client terminal), which may be integrated within the player GUI layer, for example, the player GUI layer may access the video player using an application programming interface (API), or software development kit (SDK) to play the selected video segment according to the instructions of the metadata file associated with the user selected chapter object.

The video segment may be played according to the user navigation, for example, the video segment of the received user selected chapter object (e.g., the user selected the UI template representing the chapter object). The video segments may be played in order of chapter objects defined by the metadata file, optionally continuously (i.e., seamlessly, back to back).

The segment of the video of the selected UI template (or the UI template reached in order during continuous play) may be played within the player GUI layer, by streaming the segment from video server 212 and/or playing a locally stored copy of the segment (e.g., from data repository 220), and/or from other locations.

Optionally, chapter analytics are collected based on user actions performed on the chapter objects. The analytics may be stored on metadata server 208 in association with each respective chapter object, or on another data server. The analytics may be collected and/or analyzed, for example, to identify user activity for each chapter object. The analytics may be used for monetization purposes, for example, to help match ads with chapter objects, pay sponsors of chapter objects, and/or bill advertisers. Examples of chapter analytics include: chapter object views, chapter object shares, chapter object clicks, time spent on each chapter object, comparing performance of different chapter object parameters (e.g., chapter objects with thumbnail images versus thumbnail animated GIFs versus thumbnail videos vs. thumbnail colors vs. no thumbnail), and number of chapter objects associated with each video.

At 116, the user may edit one or more of the chapter objects, create new chapter object(s), and/or delete one or more chapter objects. The editing may be performed using rendered player GUI layer, or another UI application.

It is noted that block 116 may be performed before block 102, and/or in an iterative feedback loop, for example, the user may create new chapter objects and embed the new chapter objects in a network document that is accessed by another user. In another example, the user may edit chapter objects, and then access the new chapter objects using the same (or a different) network document.

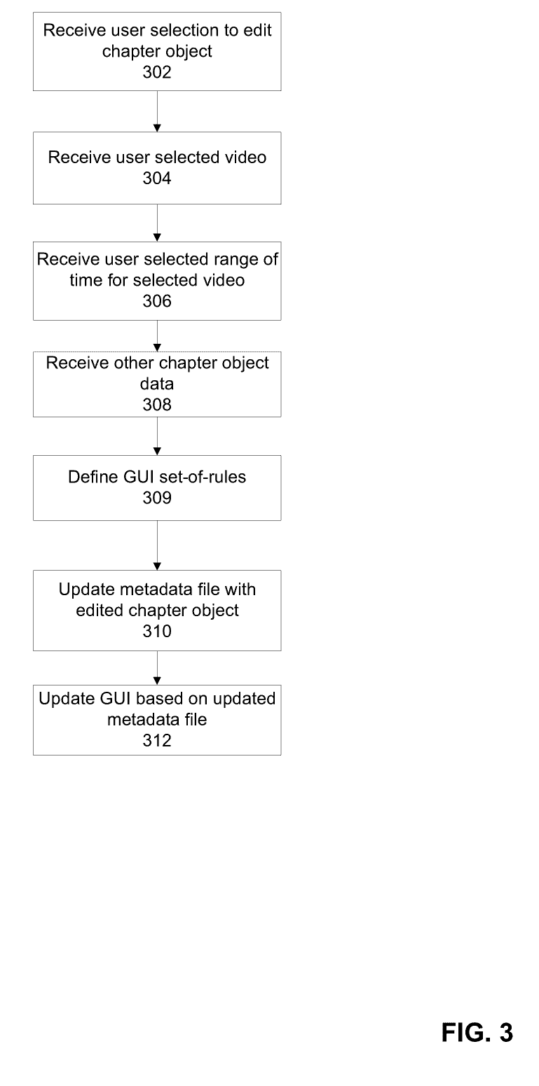

Reference is now made to FIG. 3, which is a flowchart of a computer implemented method for editing chapter objects, in accordance with some embodiments of the present invention. As used herein, the term editing may include one or more of: creating a new chapter object, changing an existing chapter object, and deleting an existing chapter object. Creation of new chapter objects may be performed relative to ordering of other existing chapter objects, for example, creating a new chapter object before or after an existing chapter object. Creation of new chapter objects may be performed from scratch, without relation to other existing chapter objects, for example, as a set of new chapter objects not defined relative to other existing chapter objects.

The acts of the method described with reference to FIG. 3 may be performed by player code 214, or other code stored in program store 216, implemented by processor 218 of client terminal 204.

At 302, a user selection for creation of a new chapter object is received, for example, by the user selecting an icon to create a new chapter object. The new chapter object may be created within a location related to the order of the presented UI templates representing chapter objects, and/or within an empty player GUI layer (i.e., the first new chapter object in a new set). Alternatively, the user selection is for changing of a current chapter object, for example by the user selecting the chapter object and/or an icon representing editing. Alternatively, the user selection is to delete an existing chapter object, for example, by selecting the chapter object and/or an icon representing deletion of the chapter object.

At 304, a user selection of a video to associate with the new and/or edited chapter object is received. The user may enter a link to the video hosted by a video server, and/or upload a new video file (which may then be forward to the video server and/or stored in another location).

The player GUI layer may communicate with video server 212 (or other location storing videos 210), allowing the user to upload one or more videos using the player GUI layer to video server 212 for using to define the video segment.

Alternatively or additionally, the player GUI layer allows the user to import a video link(s) from video servers 212 for defining the video segment.

At 306, a range of time representing a segment of the user selected video is received. For example, the user may manually enter the start time and end time and/or elapsed time from start time. In another example, the user may play the video and/or scroll through the video, and press an icon indicating the start of the segment and/or end of the segment. The start time and/or end time of the segment may be located an elapsed amount of time from the start and/or end of the complete video. One of the start or end time may be defined as the respective start or end time of the complete video.

Optionally, when a sequence of chapter objects is created, the default start time for the new segment may seamlessly follow the end time of the video segment of the previous chapter object.

Optionally, code instructions analyze the selected complete video to automatically identify segments, and/or automatically identify locations in the video which are suitable for start and/or end of segments. The automatic identified segments and/or break locations may be presented to the user using the player GUI layer for selection.

At 308, the user may enter one or more other metadata file parameters, as discussed herein. Alternatively or additionally, one or more of the metadata file parameters may automatically be created.

The player GUI layer may include code to allow the user to perform one or more of the following:

The user may define a text layer over the video segment (e.g., description, title), which may be defined as on or off.

The user may shuffle the sequence of created chapters, for example, by dragging and dropping the chapter objects (e.g., using tabs).

The user may select the color of each chapter object (e.g., the color of a tab).

The user may upload custom background images and/or animations for each chapter object, for example, using a locally stored file, and/or a remotely located file (e.g., using a URL).

The user may render a preview of the chapter object, and/or view a preview of the selected video segment.

The user may add branded bumper clips as introductory or concluding chapters.

The user may add an interactive application to the chapter object, for example, to present as a player GUI layer overlay over the playing video segment, for example, a poll or trivia question(s).

The user may hyperlink text within the headline, description, or other metadata parameters. The user may add smart annotations to the chapter object, for example, for display as an overlay during a time portion of the video segment. The user may add unique tags to the chapter object, manually and/or automatically, for example, a tag indicative of the genre of the content of the video segment.

The user may copy and/or paste chapter objects inside other chapter objects.

The user may link one chapter object with another chapter object, for example, by designating data such as headlines and/or description as hyperlinks to other chapter objects.

At 309, a GUI set-of-rules may be defined for the user created and/or edited chapter objects. For example, the user may assign an age appropriate rating to the chapter object, so that age appropriate content of the chapter object is presented based on user age. In another example, the set-of-rules may be defined to present chapter objects based on the hosting webpage, for example, the set-of-rules may query the hosting webpage to obtain up-to-date data, and organize and/or select the chapter objects based on the up-to-date information, such as downloading a ranking of the baseball batting averages of the top players, and presenting chapter objects for the top players where each chapter object includes a clip from a baseball game showing the top player batting.

At 310, metadata file 206 stored on metadata sever 208 and/or the locally stored copy of the metadata file (e.g., stored in data repository 220) is automatically updated with the newly created chapter object, and/or the changed chapter object, and/or to delete the selected chapter object. The metadata file may be automatically updated to include instructions for playing the segment of the video (e.g., the network location of the video, and/or start and/or end times of the video representing the segment). The automatic updating may be performed by player code 214.

The GUI set-of-rules may be stored within or in association with the metadata file.

At 312, the rendered player GUI layer may be automatically updated based on the updated metadata file. The updated player GUI layer includes the new created chapter object as a UI template with optional thumbnail image and/or headline (e.g., as described herein), and/or includes the updated video segment (optionally with updated thumbnail image and/or headline), and/or excludes the deleted chapter object.

The user may embed single chapter objects, a sub-set of chapter objects, or the set of chapter objects, for example, using code, a script, a URL, or other methods. The chapter object(s) may be embedded in network documents, such as web pages.

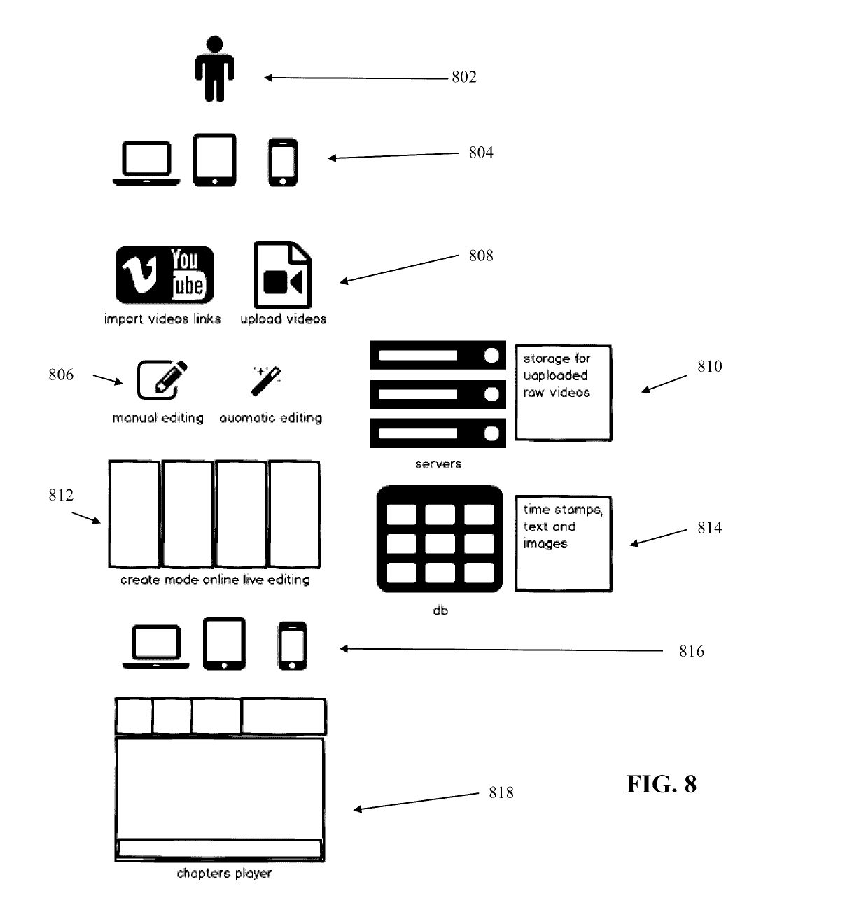

Reference is now made to FIG. 8, which is a schematic of components based on the systems and/or methods described herein for editing chapter objects, in accordance with some embodiments of the present invention. A user 802 may access a client terminal 804 to edit chapter objects. Editing 806 may be performed manually and/or automatically. Links to complete videos or complete videos 808 may be uploaded for storage by video server 810. Player GUI layer 812 is used to edit chapter objects. Metadata file 814 is automatically and/or manually updated with the chapter object and/or other data. Other client terminals 816 may present rendered player GUI layer 818 for playing the video segments based on the user edited chapter objects.

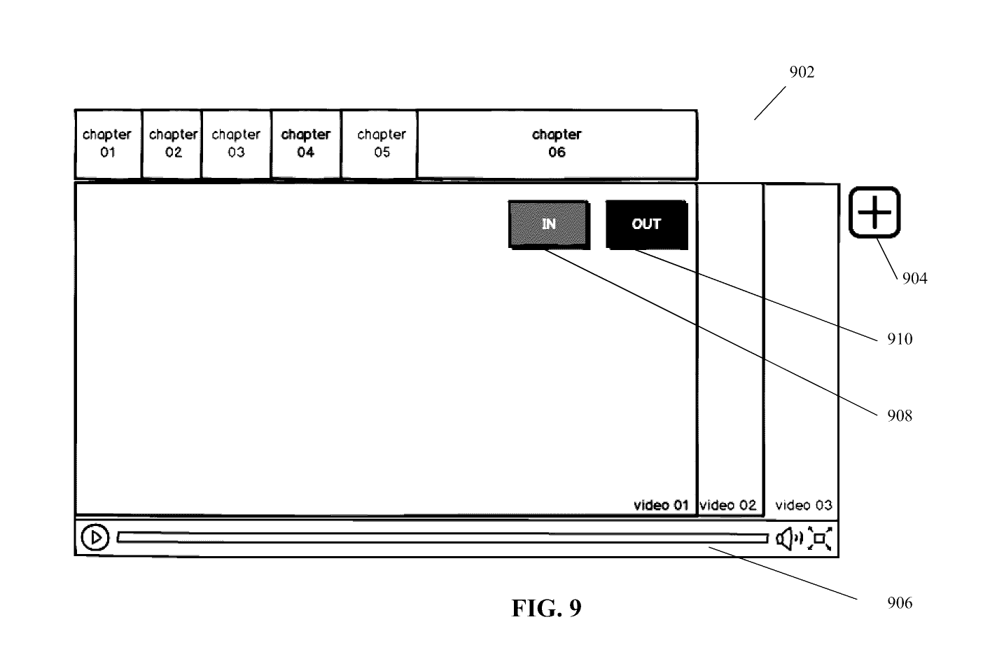

Reference is now made to FIG. 9, which is a schematic of an exemplary player GUI layer for editing chapter objects, in accordance with some embodiments of the present invention. New chapter objects may be added using icon 902. New video segments associated with the chapter object may be added using icon 904. Bar 906 may be used to navigate the complete video for selection of the segment for the chapter object. The segment may be defined by marking the start time, using IN icon 908, and marking the end time using OUT icon 910.

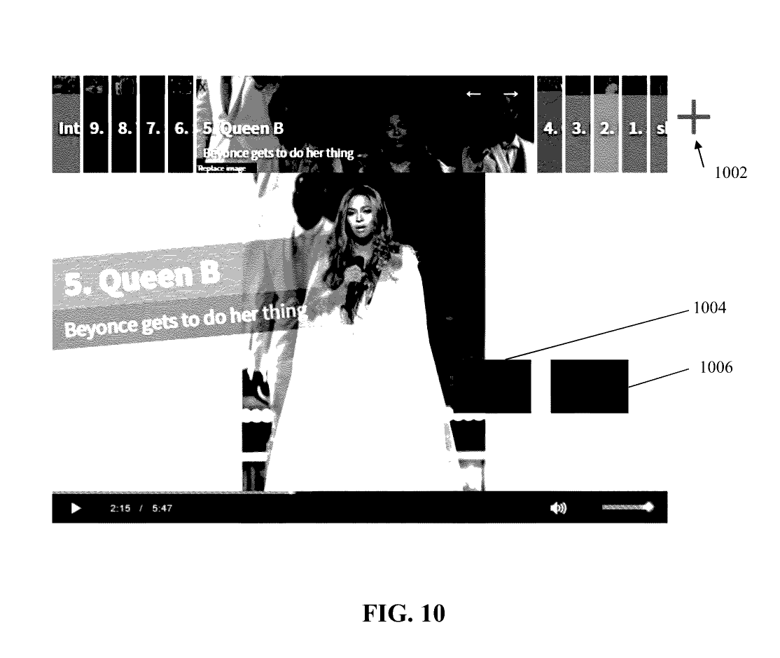

Reference is now made to FIG. 10, which is a screen capture of an exemplary implementation of a player GUI layer for editing chapter objects, in accordance with some embodiments of the present invention. Selection of icon 1002 adds a new chapter object, optionally in order relative to the currently selected chapter object. The segment associated with the new chapter object may be selected from a complete video by selecting start and stop times from the complete videos, using respective icons 1004 and 1006.

Referring now back to FIG. 1, at 118, the locally stored copy of metadata file 206 and/or locally stored copies of video segments 210 (e.g., stored in data repository 220) may be released from storage, for example, deleted, or marked as allowed to be written over.

The release from memory may be instructed by player code 214 (or other code) when execution of the rendered player GUI layer is terminated, for example, when the player GUI layer is closed by the user, and/or when the network document is closed by the user.

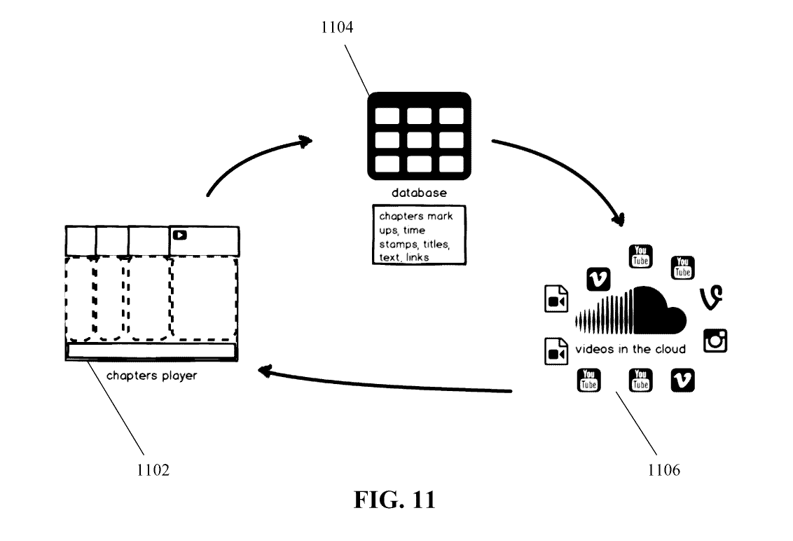

Reference is now made to FIG. 11, which is a schematic representing high-level dataflow based on the method described with reference to FIG. 1 and/or system 200 described with reference to FIG. 2, in accordance with some embodiments of the present invention. A player GUI layer 1102 is rendered by player code accessing a database 1104 (e.g., hosted by a metadata server) storing a metadata file to obtain data related to chapter objects. Videos 1106 stored in a computing cloud (e.g., video servers) are accessed based on the metadata file. Player GUI layer 1102 is rendered to include UI templates based on the chapter objects of the metadata file 1104 and to play associated segments of videos 1106.

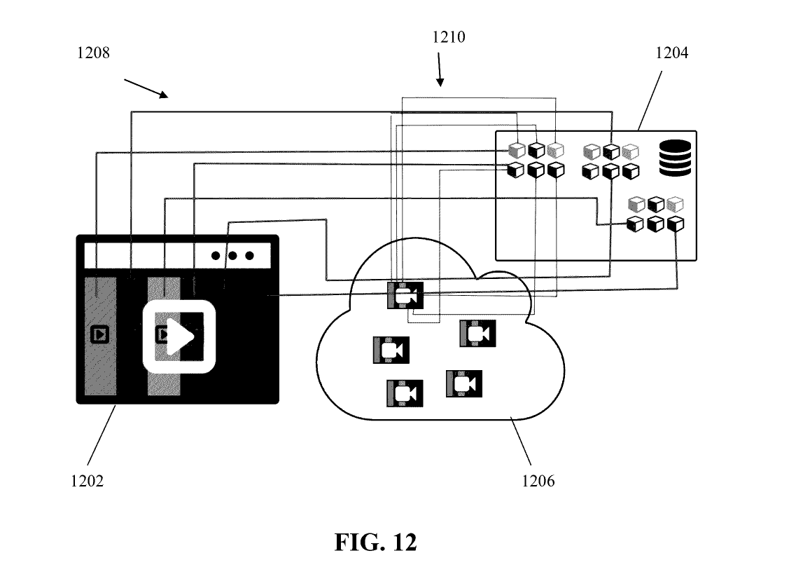

Reference is now made to FIG. 12, which is another schematic representing high-level dataflow based on the method described with reference to FIG. 1 and/or system 200 described with reference to FIG. 2, in accordance with some embodiments of the present invention. Each UI template of player GUI layer 1202 representing a chapter object maps (represented by mapping lines 1208) to the associated data of the chapter object in metadata file 1204. Metadata file 1204 maps (represented by mapping lines 1210) to segments of one or more videos 1206.

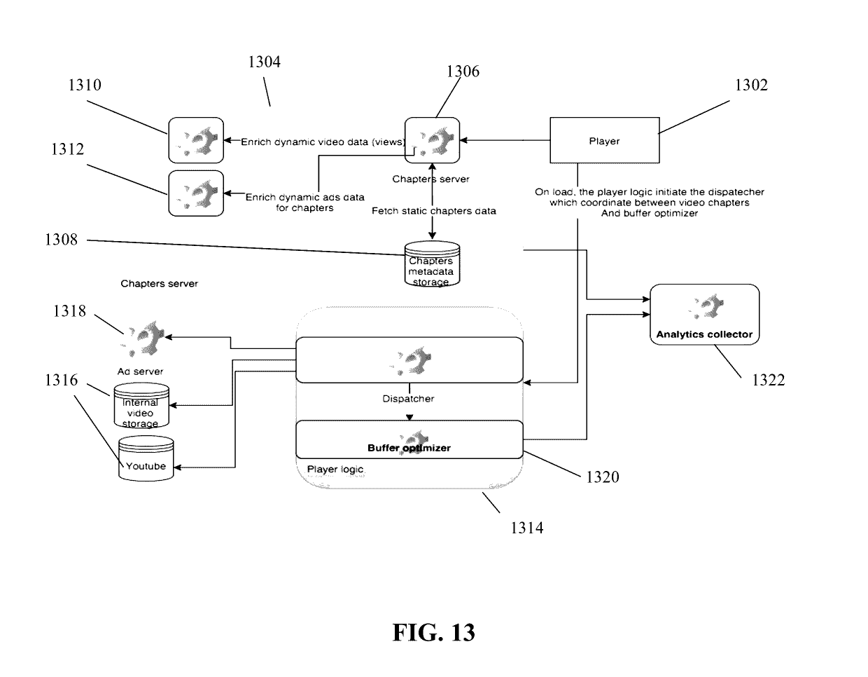

Reference is now made to FIG. 13, which is a high-level block diagram depicting dataflow between different components, in accordance with some embodiments of the present invention. Player code 1302 (e.g., stored in a program store implementable by a processor of a client terminal) accesses a chapter object server 1304 (e.g., corresponding to the metadata server described herein). Code 1306 fetches the metadata file from storage 1308. Code 1306 may add dynamic data to the metadata file, by accessing code 1310 to obtain update viewing statistics and/or code 1312 to obtain ads. The dynamic data may be calculated in real-time, and/or updated in real-time. Player code 1302 analyses the retrieved metadata file using player logic code 1314 to access relevant video segments associated with chapter objects from video servers 1316, which may include other storage locations (e.g., local storage). Code 1314 may access an ad server 1318 to obtain one or more ads to show with the video segment. Buffer code 1320 may order, stream, and/or buffer the video segments associated with the chapter objects. Analytics collector code 1322 may collect viewing data, and/or other use data.

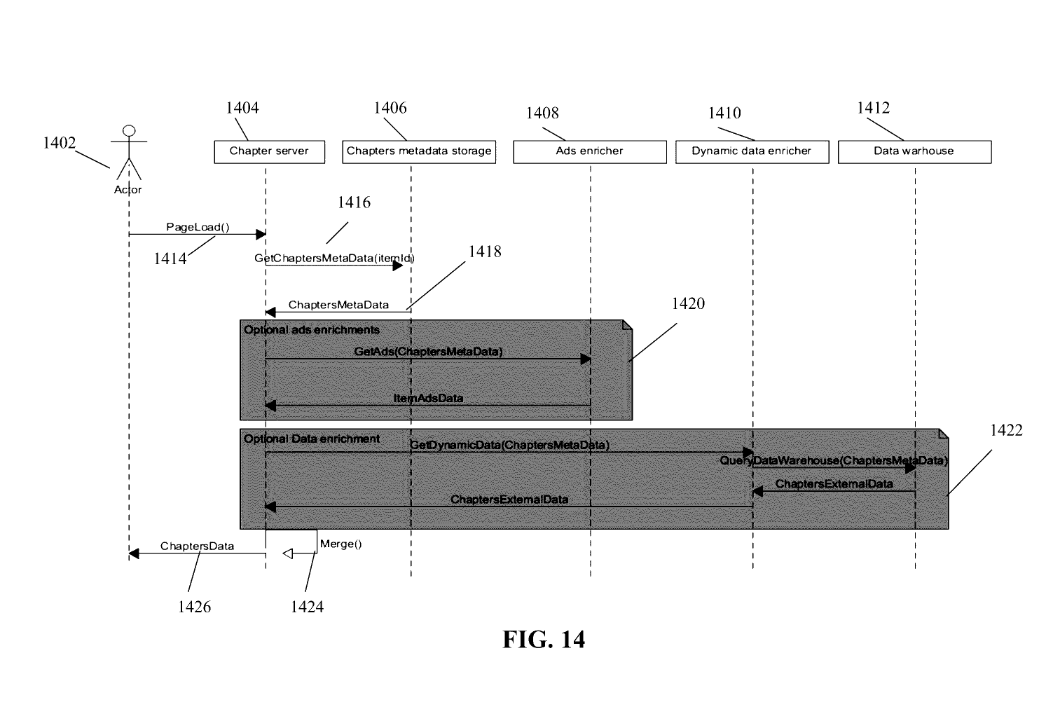

Reference is now made to FIG. 14, which is a dataflow diagram depicting flow of data between different system components, based on the systems and/or methods described herein, in accordance with some embodiments of the present invention. The dataflow diagram depicts exemplary dataflow to obtain the chapter object from the metadata file by the player code at the client terminal. The dataflow is shown between client terminal 1402, chapter server 1404 (i.e., metadata server), metadata storage 1406, ad enricher 1408 (e.g., code implemented by a processor of a server), dynamic data enricher 1410 (e.g., code implemented by a processor of a server), and data warehouse 1412 e.g., code implemented by a processor of a server).

At 1414, a webpage is loaded by client terminal 1402, triggering a request to chapter server 1404 (which may perform an authentication). A request for metadata 1416 is issued to metadata storage 1406 (which may parse the metadata), and send the metadata back to server 1404, at 1418. At 1420, ads for presentation with the chapter objects may be requested by issuing a request to ads enricher 1408. At 1422, dynamic data may be obtained, by issuing a request to dynamic data enricher 1410, which may retrieve the data from data warehouse 1412, for example, a translation, viewing statistics, or other dynamic data. The dynamic data request may be made in a single request for all chapter objects, to reduce network traffic. At 1424, chapter server 1404 merges the dynamic and static data into the chapter object, which at 1426 is delivered for rendering and presentation of the player GUI layer at client terminal 1402.

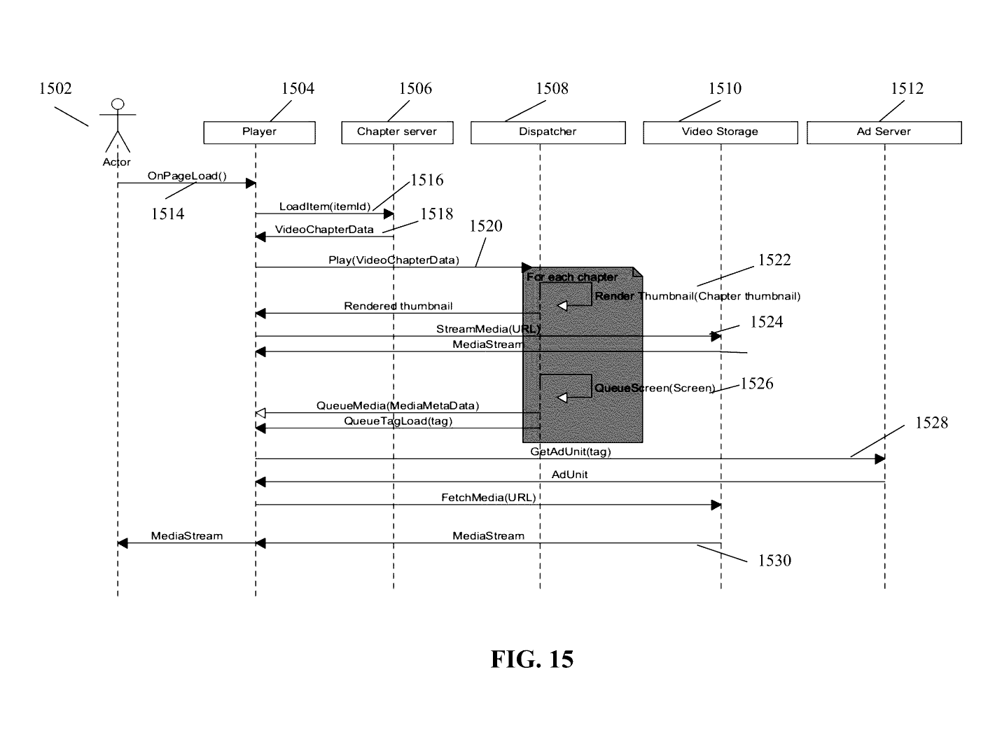

Reference is now made to FIG. 15, which is another dataflow diagram depicting flow of data between different system components, based on the systems and/or methods described herein, in accordance with some embodiments of the present invention. The dataflow diagram of FIG. 15 may follow the dataflow discussed with reference to FIG. 14, depicts exemplary dataflow after the chapter object data is received by the player code at the client terminal. The dataflow is shown between client terminal 1502, player code 1504 (installed on client terminal 1502) chapter server 1506 (i.e., metadata server), dispatcher 1508 (e.g., code implemented by client terminal 1502), video storage 1510 (e.g., video server), and ad server 1512.

1514, 1516, and 1518 represent dataflow 1414-1426 described with reference to FIG. 14. At 1520, player 1504 issues a request to dispatcher 1508 to play the video segments associated with the chapter objects. At 1522, the thumbnail of each chapter object is retrieved from storage, rendered, and/or automatically generated, and provided to player 1504. Ad configuration may be loaded for each chapter object. In the case of sub-chapters, the thumbnail for each sub-chapter may be loaded. At 1524, a request to stream the segment of the complete video is sent to video server 1510 and received by player 1504, for the first chapter object or first sub-chapter object. When an auto-play flag is set, client terminal 1502 may start playing the video segment. At 1526, video segments associated with other chapter objects may be queued, and/or prepared for presentation in the player GUI layer. The video segments may be temporarily locally stored on client terminal 1502 when the web page is loaded. At 1528, ads to present in associated with the chapter objects are obtained from ad server 1512. At 1530, the video segment is streamed to client terminal 1502, for presentation within the rendered player GUI layer.

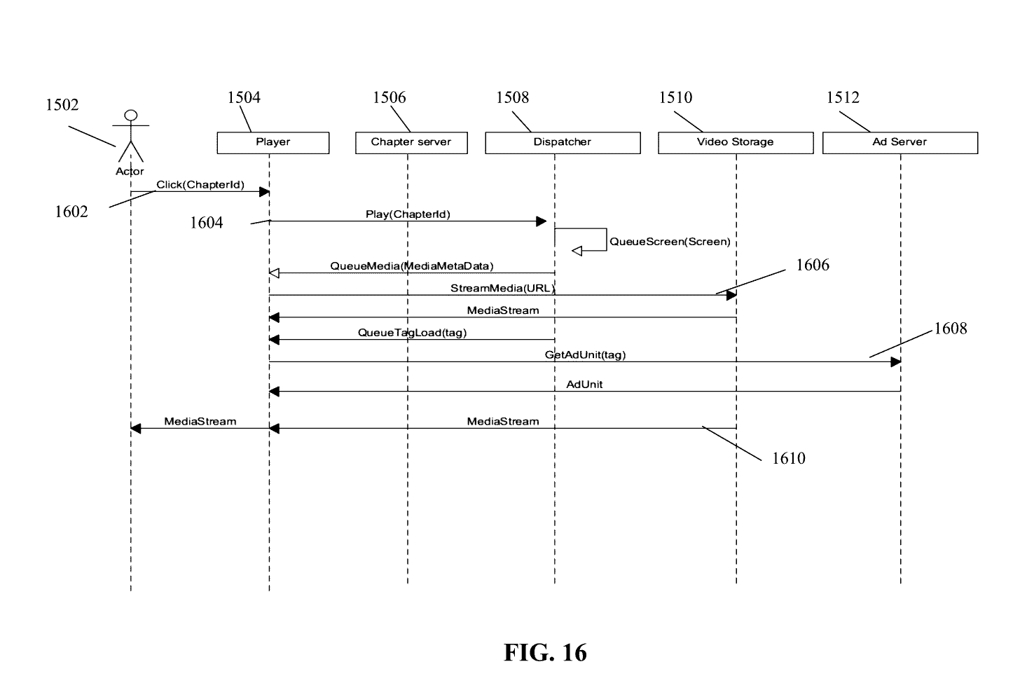

Reference is now made to FIG. 16, which is another dataflow diagram depicting flow of data between different system components, based on the systems and/or methods described herein, in accordance with some embodiments of the present invention. The dataflow diagram of FIG. 16 may follow the dataflow discussed with reference to FIG. 15, depicts exemplary dataflow when a user selects one of the chapter objects using the rendered player GUI layer, which is a different chapter object than the chapter object associated with the playing video segment.

At 1602, a user selection of one of the chapter objects is received by player code 1504. At 1604, a request to play the video segment of the selected chapter object is transmitted to dispatcher 1508, which may assign the video segment to a queue. At 1606, a request to stream the video segment of the selected chapter object is transmitted to video storage 1510. Ad may be loaded for presentation in association with the selected chapter object by transmitting a request (1608) to ad server 1512. At 1610, the video segment associated to the selected chapter object is streamed to client terminal 1502 and played within the rendered player GUI layer.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant videos and servers will be developed and the scope of the terms videos and servers are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computerized method for playing video at a client terminal, delivered from at least one server over a network according to a metadata file, the method performed by player code implemented by a processor of the client terminal, the method comprising:
accessing, from a first server, a selected instruction set from a metadata file storing a plurality of instruction sets each for adapting a player graphical user interface (GUI) layer according to user selected content including a plurality of segments selected from at least one video;
accessing, from at least one second server, the at least one video;
analyzing the selected instruction set of the metadata file to identify a plurality of chapter objects, each chapter object including instructions for playing a segment of the at least one video;
rendering, according to the selected instruction set, a player GUI layer for presentation of a plurality of segments of the at least one video on a display of the client terminal, by adapting the player GUI layer by mapping each of a plurality of user interface (UI) templates to one of the plurality of chapter objects; and
receiving a user selection of one of the UI templates of the plurality of UI templates, and presenting the chapter object associated with the selected UI template while another chapter object associated with another UI template is simultaneously displayed.

2. The method of claim 1, further comprising:
receiving a user selection of a certain UI template of the plurality of UI templates; and
playing, within the player GUI layer, the segment of the video associated with the selected certain UI template according to instructions defined by the metadata file for the respective chapter object of the plurality of chapter objects, by obtaining the segment of the at least one video from the at least one second server over the network.

3. The method of claim 1, further comprising:
accessing, from the first server, a GUI set-of-rules associated with the selected instruction set;
executing the GUI set-of-rules; and
customizing the rendered player GUI layer according to the GUI-set-of-rules.

4. The method of claim 3, wherein executing the GUI set-of-rules comprises obtaining a user profile, and customizing comprises displaying chapter objects appropriate to a user based on the user profile.

5. The method of claim 3, wherein executing the GUI set-of-rules comprises querying available resources within a local environment of the client terminal, and customizing comprises adjusting the chapter objects for presentation based on the available resources.

6. The method of claim 3, wherein executing the GUI set-of-rules comprises querying a webpage associated with the selected instruction set for up-to-date data, and customizing comprises customizing the rendered player GUI layer based on the up-to-date data.

7. The method of claim 1, further comprising automatically updating each UI template according to content of the segment of the video associated with each respective chapter object according to the metadata file, by presenting an image from the content within the UI template.

8. The method of claim 1, further comprising automatically updating each UI template with text associated with each respective chapter object according to the metadata file.

9. The method of claim 1, wherein the metadata file includes a network address for obtaining at least one video, wherein the at least one second server is accessed according to the network address.

10. The method of claim 1, wherein the metadata file defines, for each chapter object, a range of time of the video associated with the chapter object, wherein the range of time is shorter than the full range of time of the video.

11. The method of claim 1, further comprising identifying a user selection of a network document, and wherein the accessing the metadata file from the first server is performed in response to the user selection.

12. The method of claim 1, further comprising identifying a user selection of a hyperlink, and wherein the accessing the metadata file from the first server is performed in response to the user selection.

13. The method of claim 1, wherein the metadata file includes a definition of an order of presentation of the chapter objects.

14. The method of claim 13, further comprising continuously playing the segments of the at least one video according to the order.

15. The method of claim 1, further comprising:
receiving a user selection for creation of a new chapter object within a location of the presented UI templates representing chapter objects;
receiving a user selection of at least one video hosted by at least one second server;
receiving at least one range of time representing a segment of the at least one video;
automatically updating the instruction set of the metadata file with the at least one video and associated segment according to the location; and
automatically updating the rendered player GUI layer based on the updated metadata file.

16. The method of claim 1, wherein the metadata file stores, for each chapter object, at least one member of the group consisting of: thumbnail image, headline, description, tag, share universal resource locator (URL), view metrics, like, dislike, associated chapters, a poll, a trivia question, a smart annotation, and sub-chapter objects.

17. The method of claim 1, wherein the metadata stores instructions to present a dynamic element in association with the respective chapter object that adapts according to the image or scene of the associated video segment being played in real-time, based on content analysis performed on at least one frame dynamically extracted from the video segment.

18. The method of claim 1, wherein the metadata stores a plurality of sub-chapter objects for at least one chapter object of the plurality of chapter objects, wherein the sub-chapter objects inherit at least one metadata parameter from the at least one chapter object, wherein each sub-chapter object is stored as an independent chapter object.

19. The method of claim 1, wherein the user selects the order for presentation of the video segments of the chapter objects.

20. A system for playing video, comprising:
a client terminal comprising:
a display;
a first server interface for communicating with a first server storing a metadata file storing a plurality of instruction sets each for adapting a player graphical user interface (GUI) layer according to user selected content including a plurality of segments selected from at least one video;
a second server interface for communicating with at least one second server storing the at least one video;
a program store storing player code; and
a processor coupled to the display, the first server interface, the second server interface, and the program store for implementing the stored player code, the player code comprising:
code to access a selected instruction set from the metadata file using the first server interface, and analyze the selected instruction set of the metadata file to identify a plurality of chapter objects, each chapter object including instructions for playing a segment of the at least one video obtained using the second server interface;
code to render, according to the selected instruction set, a player GUI layer for presentation of a plurality of segments of the at least one video on the display, by adapting the player GUI layer by mapping each of a plurality of UI templates to one of the plurality of chapter objects; and
code to receiving a user selection of one of the UI templates of the plurality of UI templates, and present the chapter object associated with the selected UI template while another chapter object associated with another UI template is simultaneously displayed.

21. The system of claim 20, wherein the player code further comprises instructions to store the selected instructions set of the metadata file in a local memory of the client terminal.

22. The system of claim 20, wherein the player code further comprises instructions for releasing the selected instruction set of the metadata file and stored videos obtained from the at least one second server, from storage in a local memory of the client terminal when execution of the rendered GUI is terminated.

23. The system of claim 20, wherein the player code further comprises instructions for presenting an indication of the chapter object of the plurality of chapter objects having a video segment being presented, and a progress icon representing elapsed time of the segment of the video being presented from the start of the segment associated with the chapter object.

24. A computer program product comprising a non-transitory computer readable storage medium storing program code thereon for implementation by a processor of a client terminal for playing video segments, the program code comprising instructions to:
access, from a first server, a selected instruction set from a metadata file storing a plurality of instruction sets each for adapting a player graphical user interface (GUI) layer according to user selected content including a plurality of segments selected from at least one video;
access, from at least one second server, the at least one video;
analyze the selected instruction set of the metadata file to identify a plurality of chapter objects, each chapter object including instructions for playing a segment of the at least one video;
render, according to the selected instruction set, a player GUI layer for presentation of a plurality of segments of the at least one video on a display of the client terminal, by adapting the player GUI layer by mapping each of a plurality of user interface (UI) templates to one of the plurality of chapter objects; and
receive a user selection of one of the UI templates of the plurality of UI templates, and presenting the chapter object associated with the selected UI template while another chapter object associated with another UI template is simultaneously displayed.
